(19) United States
(12) Patent Application Publication
(10) Pub. No.: US 2008/0245245 A1
(43) Pub. Date: Oct. 9, 2008

(54) Spray dampening valve with a seal assembly having at least a deformable end surface for use in an offset printing process

(76) Inventor: Michael A. Niemiro, Plainfield, IL (US)

Correspondence Address: PATTI, HEWITT & AREZINA LLC, ONE NORTH LASALLE STREET, 44TH FLOOR, CHICAGO, IL, 60602, US

(21) Appl. No.: 12/157,702

(22) Filed: Jun. 12, 2008

Related U.S. Application Data
(63) Continuation-in-part of application No. 11/395,984, filed on Mar. 31, 2006.

(51) Int. Cl. B41L 23/08

(52) U.S. Cl. 101/147

(57) ABSTRACT

An embodiment may have a stationary valve seat having a predefined surface and having at least one protruding portion, and a moveable plunger assembly having a seal assembly, the seal assembly having at least a deformable end surface. In a closed position the predefined surface of the stationary valve seat substantially contacts a first predetermined area of the end surface of the moveable plunger assembly. Also, in the closed position the at least one protruding portion of the stationary valve seat engages a second predetermined area of the end surface of the moveable plunger assembly.

### TECHNICAL FIELD

The invention relates generally to dampening spray systems in offset printing processes and, more specifically, to spray dampening valves in the dampening spray systems.

### BACKGROUND

In the offset printing process, a small amount of a dampening solution, i.e., water with certain additives, is supplied to the offset plate, which then comes in contact with the inking rollers, the ink adhering to the image on the plate and the dampening solution adhering to the other portions of the plate. The quantity and placement of the dampening solution must be varied for different types and densities of ink, variations in printing densities and ink coverage, and press speed. Control of the application of the dampening fluid is particularly important in four-color process, where variations will affect color. If too little fluid is applied, printing will occur in areas where none is desired. If too much fluid is applied, printing may not occur in some areas.

Various systems for dampening the plate cylinder of an offset printing apparatus are in use today. One such system employs dampening rollers that rotate partially within an open trough containing dampening fluid. The dampening rollers bear directly or indirectly against the plate cylinder, thereby supplying a film of dampening fluid to the plate cylinder. This system, however, suffers from a number of inherent disadvantages from the standpoint of both operation and maintenance. From the operational standpoint, the system is too imprecise and difficult to control. Frequently, too much or too little solution is applied to the plate roller, or at least to certain areas of the plate roller, reducing the printing quality.

Another known dampening system eliminates the open fluid container and the immersed dampening roll, and replaces them with a closed system which pumps dampening fluid as a spray onto a dampening roll train for application to the plate cylinder. In such a spray dampening system, the dampening fluid is sprayed onto the press rollers by means of a linear array of spray nozzles with the spray patterns of the individual nozzles merging to form a continuous composite spray pattern across the surface of the press roller. It is important in obtaining proper dampening that the distribution of dampening fluid be as uniform as possible. There should be no starved areas where the amount of dampening fluid is substantially less than the other areas on the surface of the roller, and the overlapping of the adjacent individual spray patterns should be minimized so that there is little or no excessive dampening fluid applied to any portion of the dampening roller.

Various attempts have been made at adjusting the amount of dampening fluid applied to the dampening roll. In known dampening systems nozzles fluctuate between open and closed positions to regulate the amount of dampening fluid applied to the rolls, nozzles are pulsed on and off with the pulse width and/or frequency being adjusted, dampening fluid is delivered through alternate laterally adjacent nozzles, etc. However, none of the known systems provide for the accuracy and repeatability that is desired for this application.

Therefore, there is a need in the art for an improved and more accurate spray dampening valve devices for use in the offset printing process.

### SUMMARY

One embodiment of the present method and apparatus encompasses an apparatus. In this embodiment the apparatus may comprise: a stationary valve seat having a predefined surface and having at least one protruding portion; and a moveable plunger assembly having a seal assembly, the seal assembly having at least a deformable end surface; wherein in a closed position the predefined surface of the stationary valve seat substantially contacts a first predetermined area of the end surface of the moveable plunger assembly, and wherein in the closed position the at least one protruding portion of the stationary valve seat engages a second predetermined area of the end surface of the moveable plunger assembly.

Another embodiment of the present method and apparatus encompasses a method. This embodiment of the method may comprise: moving a moveable plunger assembly having a seal assembly, the seal assembly having at least a deformable end surface, between a closed position that prevents fluid flow and an open position that allows fluid flow; and engaging, in the closed position, at least one protruding portion of a stationary valve seat with the deformable end surface of the seal assembly such that the at least one protruding portion is substantially embedded in the deformable end surface of the seal assembly; wherein in the closed position the predefined surface of the stationary valve seat substantially contacts the deformable end surface of the seal assembly so as to provide a repeatable accurate closed position.

### DESCRIPTION OF THE DRAWINGS

Features of exemplary implementations of the invention will become apparent from the description, the claims, and the accompanying drawings in which:

FIG. 1 is a partial cross-sectional view of one embodiment according to the present apparatus of a spray dampening valve;

FIGS. 2, 3 and 4 are partial cross-sectional views of the FIG. 1 spray dampening valve depicting operation thereof;

FIGS. 5 and 6 depict two alternative embodiments of the valve seat of the spray dampening valve;

FIGS. 7, 8 and 9 depict three alternative embodiments of the protrusions of the valve seat of the spray dampening valve;

FIG. 10 depicts another alternative embodiment of the valve seat of the spray dampening valve;

FIG. 11 is a flow diagram depicting in general an embodiment according to the present method;

FIG. 12 is another partial cross-sectional view of one embodiment according to the present apparatus of a spray dampening valve;

FIG. 13 is a schematic drawing of a spray dampening system that incorporates the present method and apparatus;

FIGS. 14-16 depict an alternative embodiment of the spray dampening valve according to the present method and apparatus;

FIGS. 17-19 depict another alternative embodiment of the spray dampening valve according to the present method and apparatus;

FIG. 20 is a partial cross-sectional view of an alternative embodiment according to the present apparatus of a spray dampening valve;

FIG. 21 depicts the valve in an open position;

FIG. 22 depicts the valve in a partially closed position;

FIG. 23 depicts the valve in a closed position;

FIGS. 24 and 25 depict two alternative embodiments of the valve seat of the spray dampening valve;

FIGS. 26, 27 and 28 depict three alternative embodiments of the protrusions of the valve seat of the spray dampening valve;

FIG. 29 depicts another alternative embodiment of the valve seat of the spray dampening valve in which the valve seat has a plurality of outlets surrounded by a protrusion;

FIG. 30 is a partial cross-sectional view of an alternative embodiment according to the present apparatus for use in a spray dampening valve;

FIG. 31 is a detailed view of a portion of the FIG. 30 embodiment; and

FIG. 32 is an end view of the seal assembly of FIG. 30.

### DETAILED DESCRIPTION

In the offset printing process, a small amount of a dampening solution, for example water with certain additives, is sprayed onto the offset plate by a plurality of solenoid valves. One embodiment encompasses short-duration impulse operation of the solenoid valves. In short-duration impulse operation, mechanical accuracy and long-term stability of a solenoid valve are largely determined by the consistency of the valve's stroke length.

In such a solenoid valve, the magnetic force applied to the armature is a function of the separation between magnetic pole pieces. The travel time of the armature affects the volume per impulse, and the travel time is a function of the stroke length.

Solenoid valves require seals for effectively terminating the spray of fluids when the valve is closed. Seals may be made of elastomers. However, elastomers used to seal valves are difficult to accurately manufacture, typically varying by about ±0.004″, or more (nominal stroke length of a spray dampening valve is 0.010″ to 0.025″). Furthermore, such elastomer seals deform with age and operation in a manner that is not consistent. This is profoundly problematic when the plunger armature rests on an elastomeric component.

Embodiments of the present method and apparatus accurately determine and maintain plunger location and valve stroke length through two mechanisms, precise location of the sealing surface, and absolute location of plunger armature after compression of valve seal.

Embodiments of the present method and apparatus may also be known as “compensated”, “spring compensated” and “spring loaded” plunger designs. In general, such a design is known to have certain features, such as: long life seal to absorb the impact against the valve seat when closing; and bounce free seal to again absorbing impact, but here to avoid reopening upon bounce, usually in pneumatic applications. Also, it is known to make the compensating spring intentionally made weak in spray dampening systems, to create a “two-mass” system with a “floating” seal. The reasoning is that the second mass, having far less inertia, moves more quickly.

Although these features may be have certain merits, accurate location of the sealing surface is more important in the application of spray dampening than avoiding wear or preventing bounce. Embodiments according to the present method and apparatus have a compensating spring that is deliberately chosen not to deflect, or create a “floating seal”.

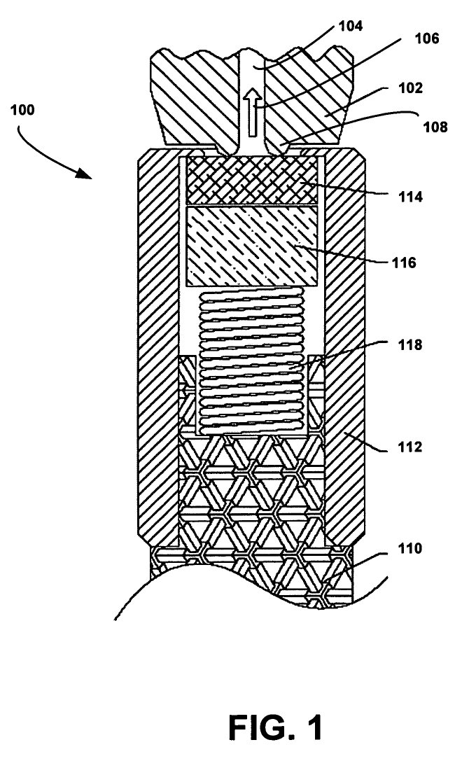

FIG. 1 is a partial cross-sectional view of one embodiment according to the present apparatus of a spray dampening valve 100. The spray dampening valve 100 may have moveable plunger body 110 and a stationary valve seat 102. When the valve 100 is open fluid may be expelled from a predetermined opening 104 in the direction 106.

The valve seat 102 is stationary, but all other components are in simultaneous motion during a valve cycle. The plunger body 110 is the fore piece of a conventional plunger armature. The spring 118 applies force to the seal backing 116, which applies that same force to the plunger seal 114 with more even distribution. The plunger seal 114 is held in place against the spring force of the spring 118 by a seal retainer 112, which is securely fastened to the plunger body 110. If other provisions are provided for retaining the plunger seal 114 in position, for example a wall may be provided behind the plunger seal 114, the spring 118 may be unnecessary.

The plunger seal may be formed from a variety of chemically resistant elastomers, and the seal backing may be formed from a variety of chemically resistant mechanically stable solid materials. The fluid, which may come in contact with the plunger seal and the seal backing, may be, for example, just water or water with a chemical additive depending upon the application. Thus the selection of material for the plunger seal and the seal backing is based on the chemical requirements of the particular application.

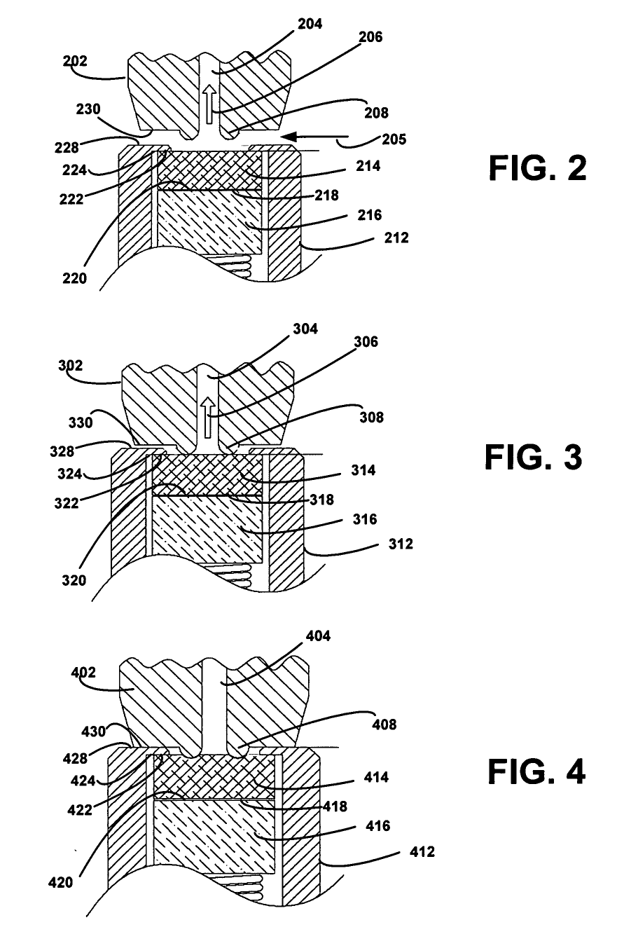

FIGS. 2, 3 and 4 are partial cross-sectional views of the FIG. 1 spray dampening valve depicting operation thereof. FIG. 2 depicts the valve in the open position. Fluid may enter along direction 205 between a predefined surface 230 of the stationary valve seat 202 and an end surface 228 of the seal retainer 212. A surface 218 of the seal backing 216 contacts a second surface 220 of the plunger seal 214, the second surface 220 of the plunger seal 214 being opposed from a first surface 222 of the plunger seal 214. The first surface 222 of the plunger seal 214 engages an inner surface 224 of the seal retainer 212.

FIG. 3 depicts the valve in a partially closed position. The predefined surface 330 of the stationary valve seat 302 now approaches the end surface 328 of the seal retainer 312. As described above the surface 318 of the seal backing 316 contacts a second surface 320 of the plunger seal 314, the second surface 320 of the plunger seal 314 being opposed from a first surface 322 of the plunger seal 314. The first surface 322 of the plunger seal 314 engages an inner surface 324 of the seal retainer 312.

FIG. 4 depicts the valve in a closed position. The predefined surface 430 of the stationary valve seat 402 now contacts the end surface 428 of the seal retainer 412. Because the predefined surface 430 of the stationary valve seat 402 and the end surface 428 of the seal retainer 412 are each composed of a material such as stainless steel the plunger location and valve stroke length is maintained and repeatable. As described above the surface 418 of the seal backing 416 contacts a second surface 420 of the plunger seal 414, the second surface 420 of the plunger seal 414 being opposed from a first surface 422 of the plunger seal 414. The first surface 422 of the plunger seal 414 engages an inner surface 424 of the seal retainer 412. Variations in the plunger seal 414 and seal backing 416 are negated in this configuration.

Furthermore, as depicted in FIG. 4, in the closed position the protruding portion or protrusion 408 of the stationary valve seat 402 indents first surface 422 of the plunger seal 414 to create a substantially fluid tight seal. The plunger seal 414 may be formed from a deformable elastomer material. The seal retainer 412 and valve seat 402 are made of solid, non-deformable materials, and rest against each other after the elastomeric plunger seal 414 undergoes compression. As such, no further deformation of the plunger seal 414 will alter the location and travel distance of the plunger armature. In order to compensate for dimensional changes to the various elements over time, an adjustment mechanism may be added to the spray dampening valve, for example, a screw element operatively coupled to the armature of the solenoid.

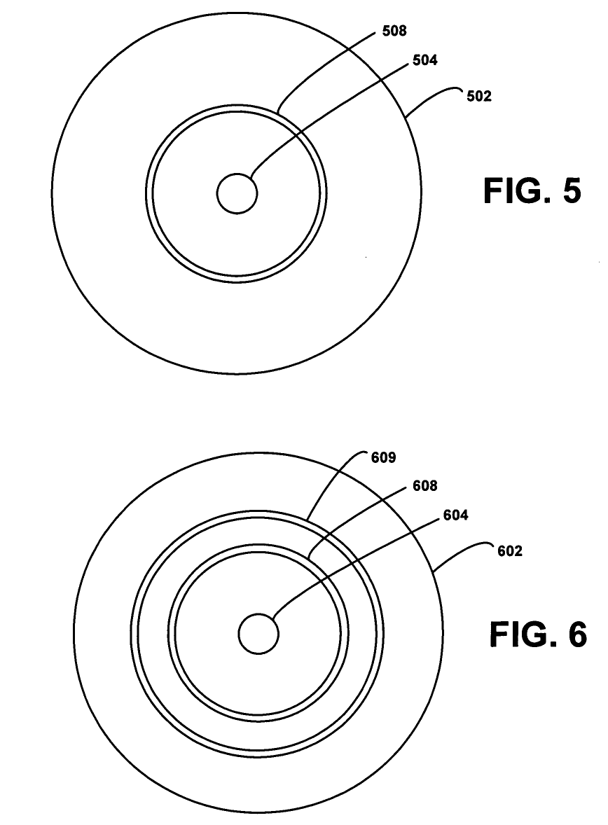

FIGS. 5 and 6 depict two alternative embodiments of the valve seat of the spray dampening valve. Embodiments of the present method and apparatus may have a variety of configurations. In one embodiment, depicted in FIG. 5, the stationary valve seat 502 may be generally circular. The predetermined outlet 504 may be centrally located and surrounded by the protrusion 508.

In the embodiment depicted in FIG. 6 a pair of concentric protrusions 608, 609 surround the predetermined outlet 604 in the valve seat 602.

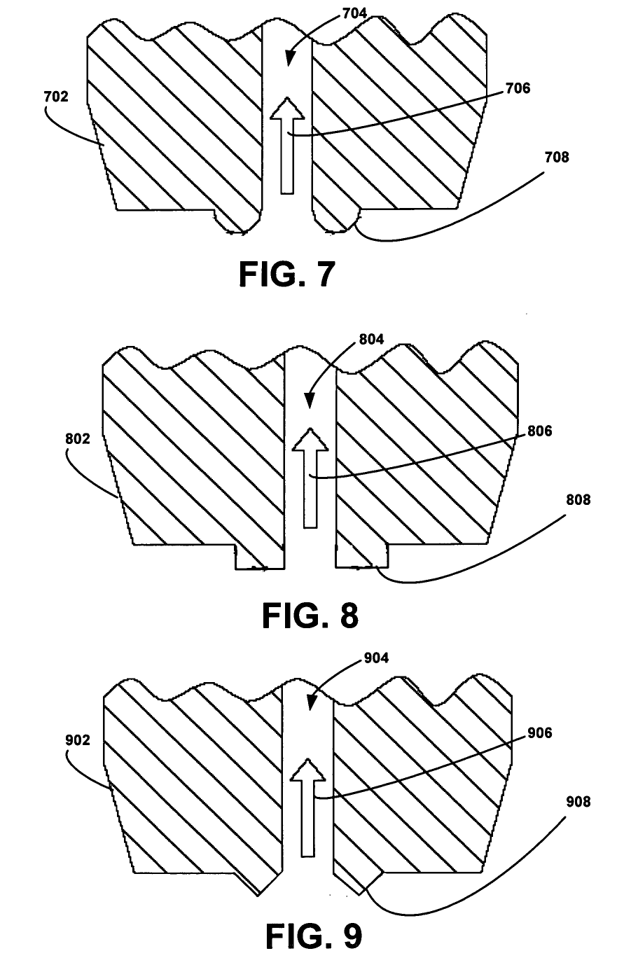

FIGS. 7, 8 and 9 depict three alternative embodiments of the protrusions of the valve seat of the spray dampening valve. In each of these embodiments the valve seat 702, 802, 902 has a fluid outlet 704, 804, 904 through which the fluid flows in the direction 706, 806, 906. In FIG. 7 the protrusion 708 may have a substantially rounded configuration, in FIG. 8 the protrusion 808 may have a substantially square configuration, and in FIG. 9 the protrusion 908 may have a substantially triangular configuration.

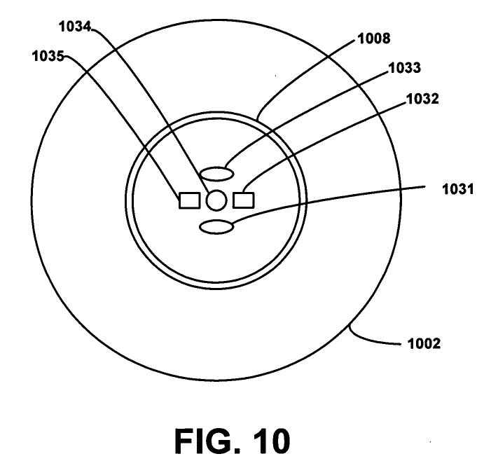

FIG. 10 depicts another alternative embodiment of the valve seat 1002 of the spray dampening valve in which the valve seat 1002 has a plurality of outlets 931, 932, 933, 934, 935 surrounded by a protrusion 1008.

Operation of the valve may be pulsed, for example, at different rates and/or patterns of open and close. The valve may also be simply turned on for a period of time depending upon the application.

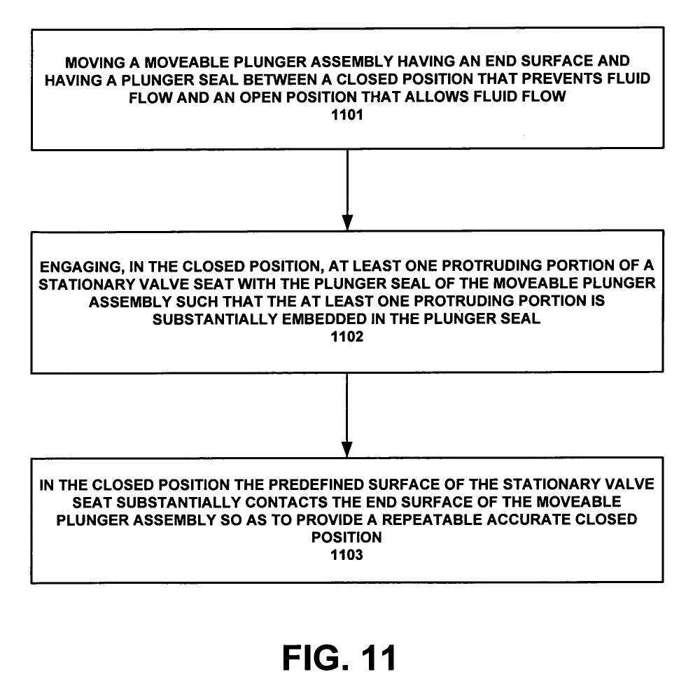

FIG. 11 is a flow diagram depicting in general an embodiment according to the present method. In this embodiment the method may have the steps of: moving a moveable plunger assembly having an end surface and having a plunger seal between a closed position that prevents fluid flow and an open position that allows fluid flow (1101); and engaging, in the closed position, at least one protruding portion of a stationary valve seat with the plunger seal of the moveable plunger assembly such that the at least one protruding portion is substantially embedded in the plunger seal (1102); wherein in the closed position the predefined surface of the stationary valve seat substantially contacts the end surface of the moveable plunger assembly so as to provide a repeatable accurate closed position (1103).

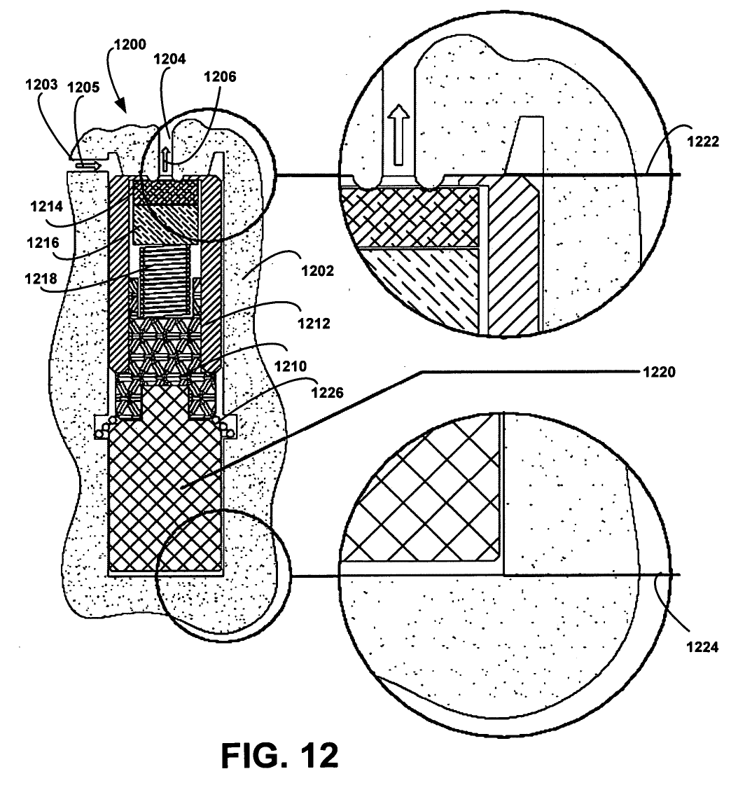

FIG. 12 is another partial cross-sectional view of one embodiment according to the present apparatus of a spray dampening valve 1200. The spray dampening valve 1200 may have moveable plunger body 1210 and a stationary valve seat 1202. When the valve 1200 is open, fluid may enter through opening 1203 in the direction 1205, and may be expelled from a predetermined opening 1204 in the direction 1206.

The valve seat 1202 is stationary, but all other components are in simultaneous motion during a valve cycle. The plunger body 1210 is coupled to a pole piece 1220 of a conventional plunger armature. The spring 1218 applies force to the seal backing 1216, which applies that same force to the plunger seal 1214 with more even distribution. The plunger seal 1214 is held in place against the spring force of the spring 1218 by a seal retainer 1212, which is securely fastened to the plunger body 110. If other provisions are provided for retaining the plunger seal 1214 in position, for example a wall may be provided behind the plunger seal 1214, the spring 1218 may be unnecessary.

The magnetic pole piece 1220 is coupled to a return spring 1226. The pole piece 1220 sets the armature in motion in response to magnetic force. It must be composed of a magnetic material, such as 43OF SS. The spring 1226 closes the valve after activation, and holds the valve shut between cycles. The exploded views show the two stop limits 1222 and 1224, which define the stroke of the valve.

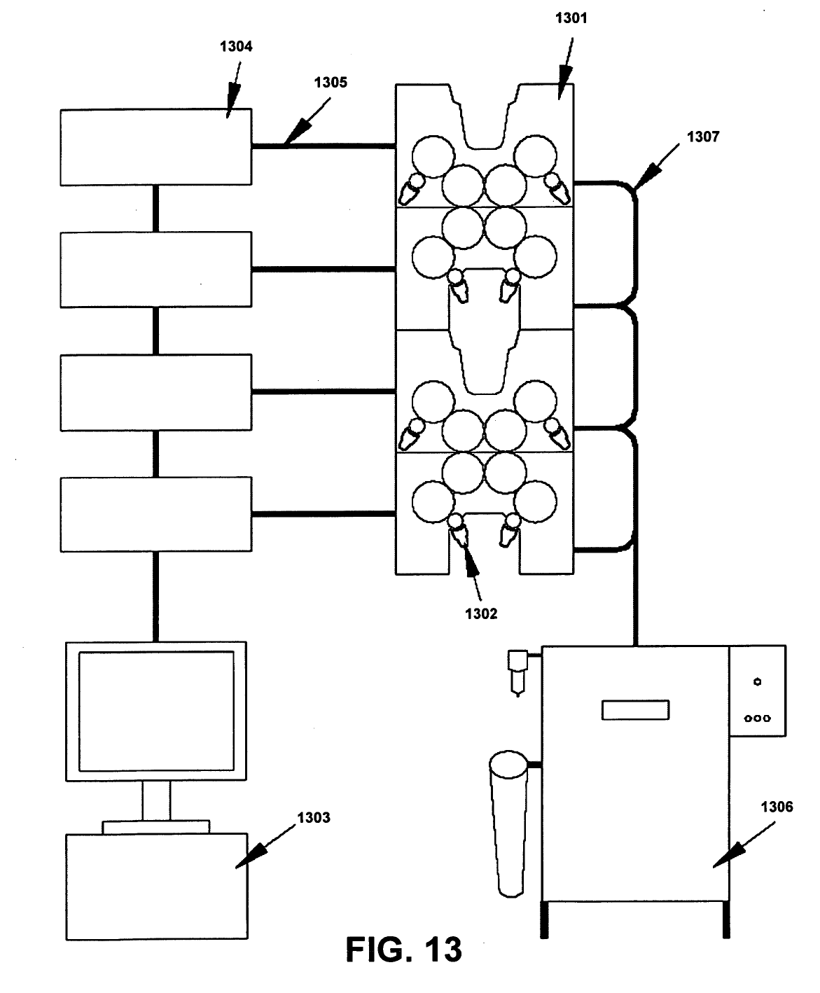

FIG. 13 is a schematic drawing of a spray dampening system that incorporates the present method and apparatus. A printing unit 1301 (for example, supplied by a press manufacturer) may be a typical four-high unit capable of creating eight independent images.

The printing unit 1301 may have a spraybar assembly 1302 that may include a spraybar and all associated mounting hardware, and mist containment equipment. The depicted printing unit 1301 uses eight spraybar assemblies 1302. A typical press may use up to sixty spraybars. A spraybar may have any number of valve assemblies, although typically it consists of eight valve assemblies.

A central system control station/user interface control unit 1303 may be responsible for all system-wide functionality, as well as serving as an operator interface for the printing unit 1301. The central system control station/user interface control unit 1303 may be operatively coupled to a spraybar controller unit 1304 which operates the spraybar assemblies 1302, based on input data from the central unit 1303. In this configuration, two spraybar assemblies 1302 are driven by one spraybar controller 1304. Electrical interconnections 1305 operatively connect the spraybar controller unit 1304 to the spraybar assemblies 1302.

Solution supply/processing equipment unit 1306 is operatively coupled to the spraybar assemblies 1302 by solution interconnection 1307. The solution supply/processing equipment unit 1306 supplies pressurized solution to spray dampeners, which are the spraybar assemblies 1302. Additional tasks of the solution supply/processing equipment unit 1306 may include mechanical/chemical/biological filtration, sterilization, chilling, chemical dosing/monitoring, and recirculation.

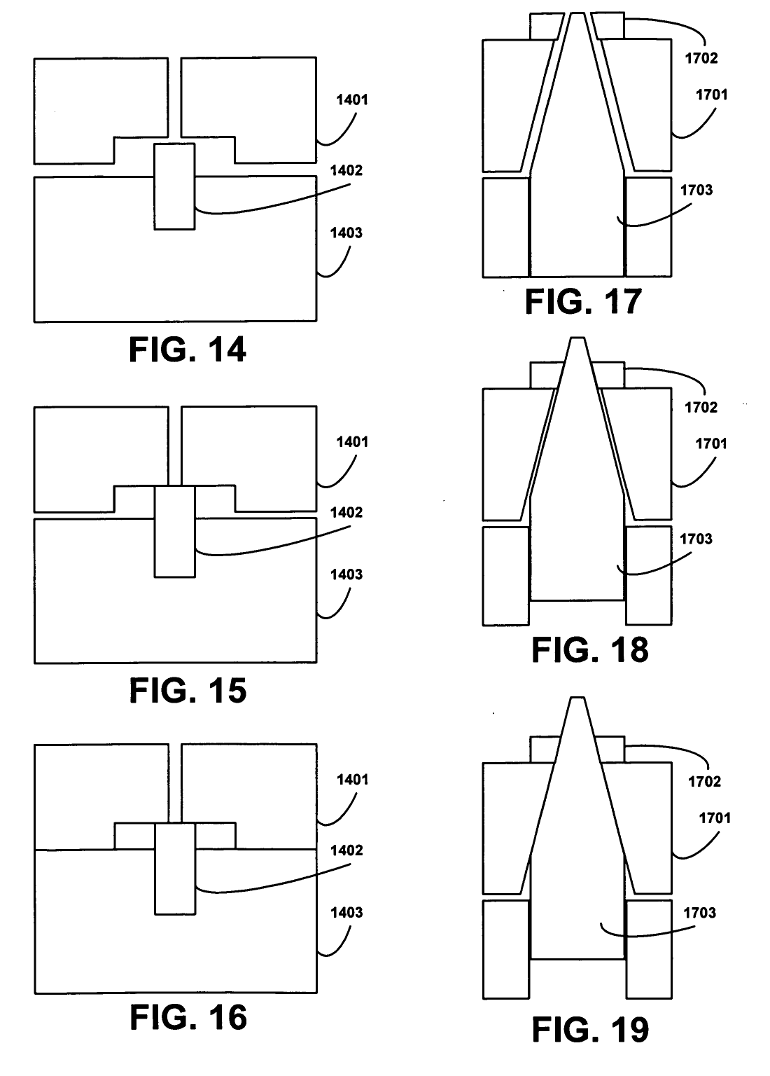

FIGS. 14, 15 and 16 schematically depict one embodiment of a spray dampening valve and operation thereof according to the present method and apparatus. FIG. 14 depicts the valve in the open position allowing fluid to flow. A valve seat 1401 is stationary and a seal retainer 1403 is moveable and has an elastomer plunger seal 1402.

FIG. 15 depicts the valve in a partially closed position. In this position the seal retainer 1403 has moved upward such that the plunger seal 1402 begins to contact the valve seat 1401.

FIG. 16 depicts the valve in a closed position. In this position the seal retainer 1403 has moved further upward such that the seal retainer 1403 contacts the valve seat 1401 preventing any further movement. No further upward movement is possible since each of the seal retainer 1403 and the valve seat 1401 are formed of substantially non-deformable materials. Also in this closed position the valve seat 1401 has compressed the plunger seal 1402 such that fluid flow is prevented.

FIGS. 17, 18 and 19 schematically depict another embodiment of a spray dampening valve and operation thereof according to the present method and apparatus. FIG. 17 depicts the valve in the open position allowing fluid to flow. A valve seat 1701 is stationary and a plunger 1703 is moveable. An elastomer plunger seal 1702 is stationary and located near an end of the plunger 1703.

FIG. 18 depicts the valve in a partially closed position. In this position the plunger 1703 has moved upward such that the plunger seal 1702 begins to contact the plunger 1703.

FIG. 19 depicts the valve in a closed position. In this position the plunger 1703 has moved further upward such that the plunger 1703 contacts the valve seat 1701 preventing any further movement. No further upward movement is possible since each of the plunger 1703 and the valve seat 1701 are formed of substantially non-deformable materials. Also in this closed position the plunger 1703 has compressed the plunger seal 1702 such that fluid flow is prevented.

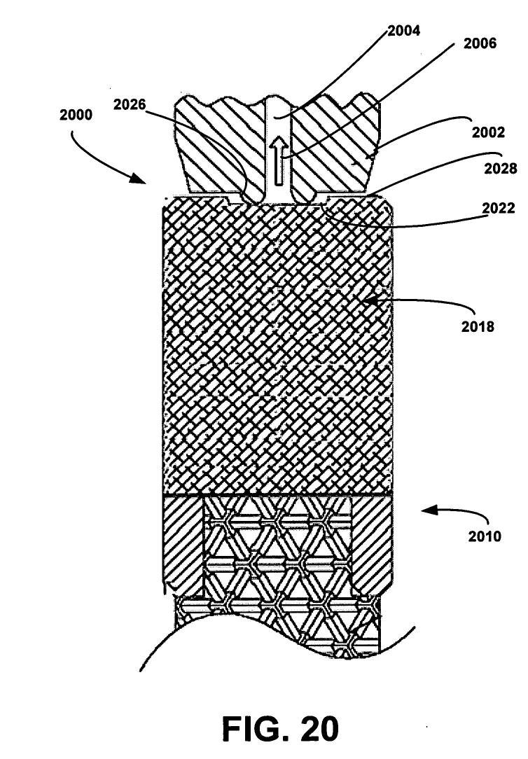

FIG. 20 is a partial cross-sectional view of an alternative embodiment according to the present apparatus of a spray dampening valve 2000. In this alternative embodiment, a one-piece elastimer seal replaces the seal backing, the plunger seal, and the seal retainer depicted in the FIG. 1 embodiment. In this embodiment the spray dampening valve 2000 may have moveable plunger assembly 2010 having a seal assembly 2014 and a stationary valve seat 2002. When the valve 2000 is open fluid may be expelled from a predetermined opening 2004 in the direction 2006. This alternative embodiment provides for quick shutoff without causing significant turbulence in the flow of dampening solution.

The valve seat 2002 is stationary, but all other components may be in simultaneous motion during a valve cycle. The plunger assembly 2010 is the fore piece of a conventional plunger armature. The seal assembly 2014 is attached to an end of the moveable plunger assembly 2010. In general the seal assembly 2014 has a surface 2028 that surrounds a recessed area 2022. The valve seat 2002 may have at least one protrusion 2026 that engages the surface 2028 of the seal assembly 2014. The use of the protrusions reduces wear and deformation.

The seal assembly 2014 may be formed from a variety of chemically resistant elastomers. The fluid, which may come in contact with the seal assembly 2014, may be, for example, just water or water with a chemical additive depending upon the application. Thus the selection of material, such as an elastomer, for the seal assembly 2014 is based on the chemical requirements of the particular application. Also, a soft plastic is also a possible material, especially for embodiments that are not for long life. This version has high predictability regarding movement of the valve.

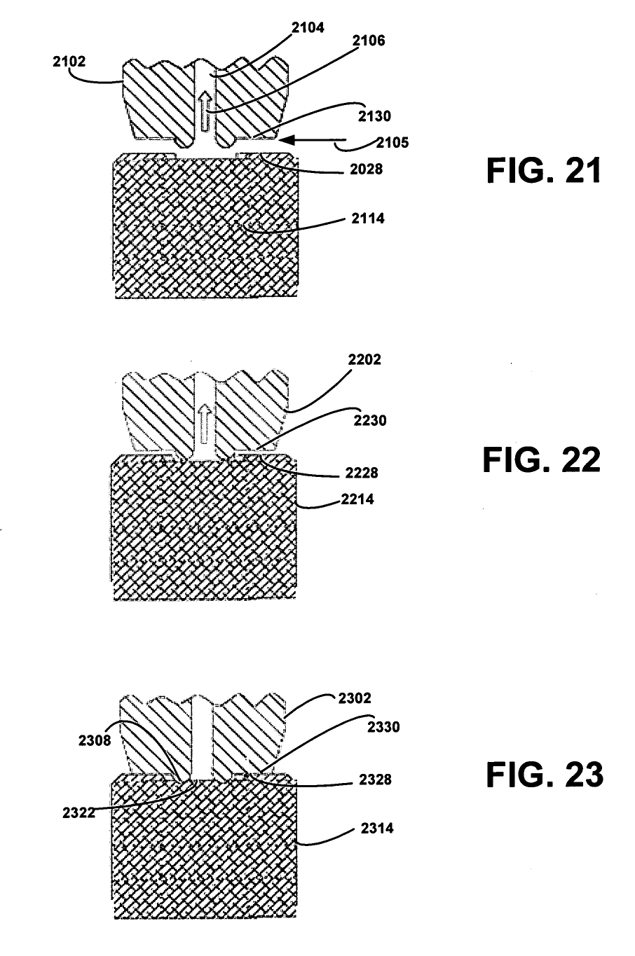

FIGS. 21, 22 and 23 are partial cross-sectional views of the FIG. 20 spray dampening valve depicting operation thereof. FIG. 21 depicts the valve in the open position. Fluid may enter along direction 2105 between a predefined surface 2130 of the stationary valve seat 2102 and an end surface 2128 of the seal assembly 2114. When the valve is open fluid may be expelled from a predetermined opening 2104 in the direction 2106.

FIG. 22 depicts the valve in a partially closed position. The predefined surface 2230 of the stationary valve seat 2202 now approaches the end surface 2228 of the seal assembly 2214.

FIG. 23 depicts the valve in a closed position. The predefined surface 2330 of the stationary valve seat 2302 now contacts the end surface 2328 of the seal assembly 2314. In the closed position the protruding portion or protrusion 2308 of the stationary valve seat 2302 indents the surface 2322 of the seal assembly 2314 to create a substantially fluid tight seal. The seal assembly 2314 may be formed from a deformable elastomer material as described above. The valve seat 2302 may be made of solid, non-deformable materials. The surface 2330 of the valve seat 2302 and the surface 2328 of the seal assembly 2314 rest against each other after the elastomeric area 2322 of the seal assembly 2314 undergoes compression. Thus, in the closed position the predefined surface 2330 of the stationary valve seat 2302 substantially contacts a first predetermined area, surface 2328, of the end surface of the seal assembly 2314 of the moveable plunger assembly, and also in the closed position the at least one protruding portion 2308 of the stationary valve seat 2302 engages a second predetermined area, elastomeric area 2322, of the end surface of the seal assembly 2314 of the moveable plunger assembly

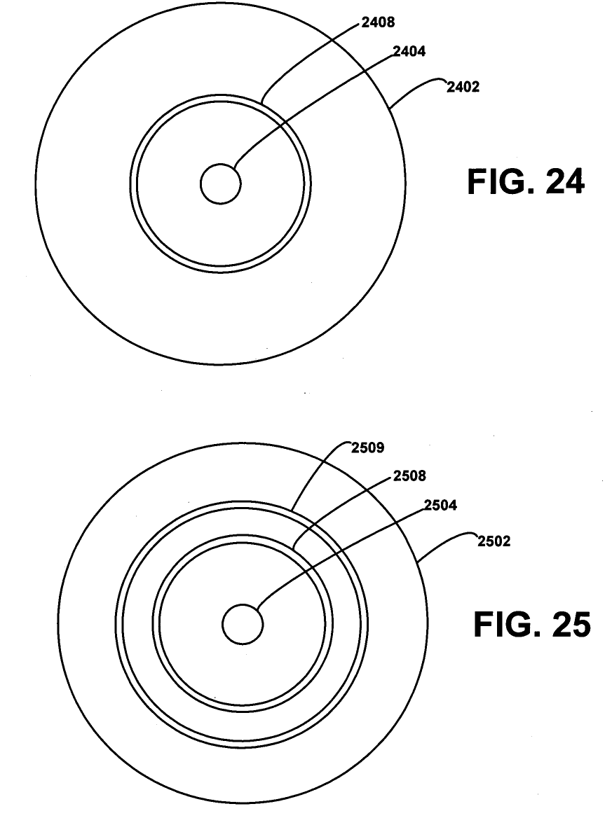

FIGS. 24 and 25 depict two alternative embodiments of the valve seat of the spray dampening valve. Embodiments of the present method and apparatus may have a variety of configurations. In one embodiment, depicted in FIG. 24, the stationary valve seat 2402 may be generally circular. The predetermined outlet 2404 may be centrally located and surrounded by the protrusion 2408. In the embodiment depicted in FIG. 25 a pair of concentric protrusions 2508, 2509 surround the predetermined outlet 2504 in the valve seat 2502.

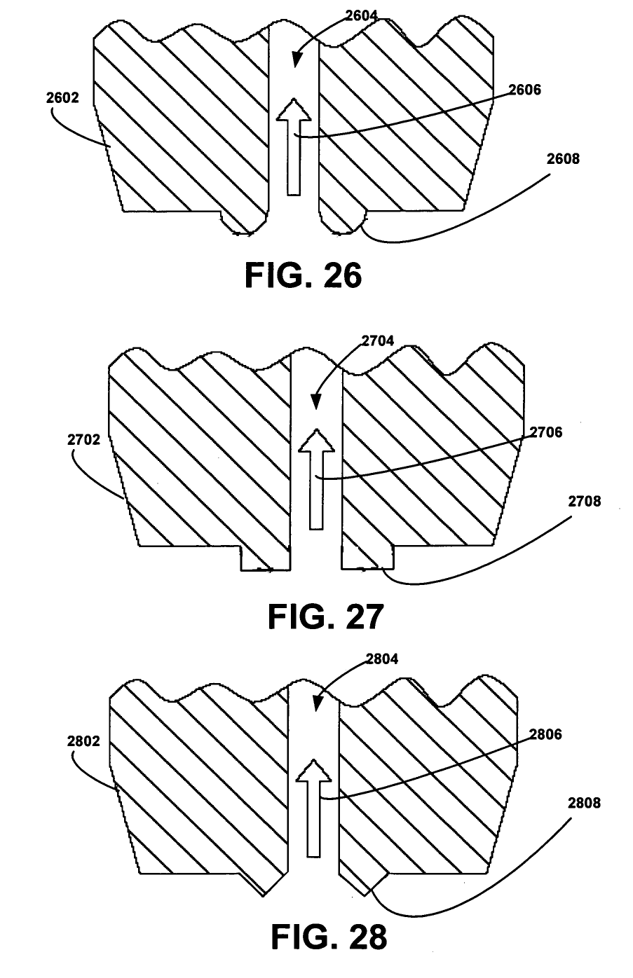

FIGS. 26, 27 and 28 depict three alternative embodiments of the protrusions of the valve seat of the spray dampening valve. In each of these embodiments the valve seat 2602, 2702, 2802 has a fluid outlet 2604, 2704, 2804 through which the fluid flows in the direction 2606, 2706, 2806. In FIG. 26 the protrusion 2608 may have a substantially rounded configuration, in FIG. 27 the protrusion 2708 may have a substantially square configuration, and in FIG. 28 the protrusion 2808 may have a substantially triangular configuration.

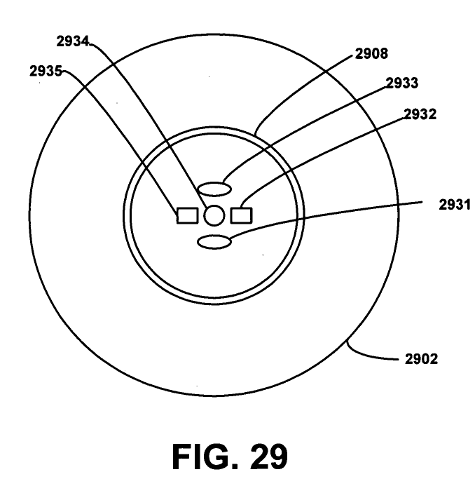

FIG. 29 depicts another alternative embodiment of the valve seat of the spray dampening valve in which the valve seat has a plurality of outlets 2931, 2932, 2933, 2934, 2935 surrounded by a protrusion 2908.

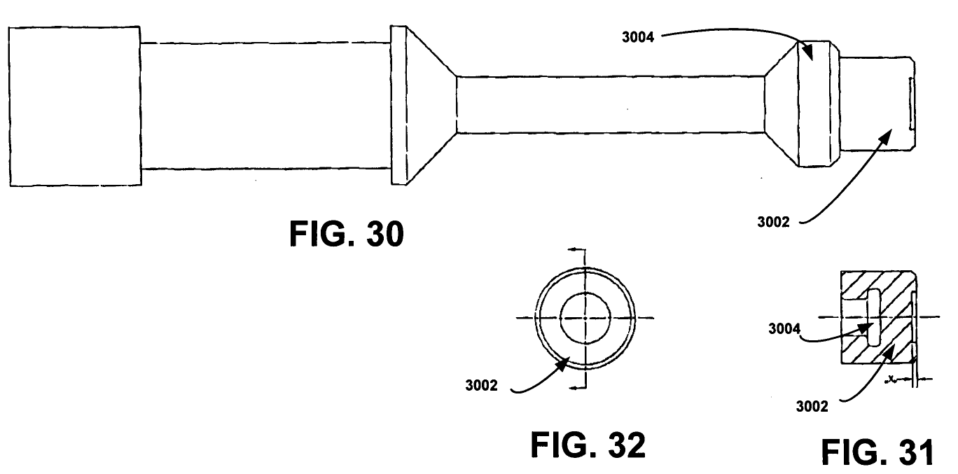

FIG. 30 is a partial cross-sectional view of an alternative embodiment according to the present apparatus for use in a spray dampening valve. In this alternative embodiment, a one-piece elastimer seal replaces the seal backing, the plunger seal, and the seal retainer depicted in the FIG. 1 embodiment. In this embodiment a seal assembly 3002 is mounted on a moveable plunger assembly 3004. FIG. 31 is a detailed view of a portion of the FIG. 30 embodiment showing how the seal assembly 3002 is attached to the moveable plunger assembly 3004. FIG. 32 is an end view of the seal assembly 3002.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus, comprising:
a stationary valve seat having a predefined surface and having at least one protruding portion; and
a moveable plunger assembly having a seal assembly, the seal assembly having at least a deformable end surface;
wherein in a closed position the predefined surface of the stationary valve seat substantially contacts a first predetermined area of the end surface of the moveable plunger assembly, and wherein in the closed position the at least one protruding portion of the stationary valve seat engages a second predetermined area of the end surface of the moveable plunger assembly.

2. The apparatus according to claim 1, wherein in the closed position the at least one protruding portion of the stationary valve seat indents the second predetermined area of the end surface of the moveable plunger assembly to create a substantially fluid tight seal.

3. The apparatus according to claim 2, wherein the seal assembly is formed from one of a deformable elastimer material and a soft plastic material.

4. The apparatus according to claim 1, wherein the end surface of the moveable plunger assembly has the second predetermined area end surface of the moveable plunger assembly recessed from the first predetermined area end surface of the moveable plunger assembly to create a predetermined opening, wherein the at least one protruding portion of the stationary valve seat extends through the predetermined opening end surface of the moveable plunger assembly to engage the second predetermined area of the end surface of the moveable plunger assembly.

5. The apparatus according to claim 4, wherein the apparatus has an open position in which the at least one protruding portion of the stationary valve seat is disengaged from the end surface of the moveable plunger assembly to allow fluid to flow through the predetermined opening.

6. The apparatus according to claim 5, wherein in the open position fluid flows into the apparatus between the predefined surface of the stationary valve seat and the end surface of the moveable plunger assembly, past the at least one protruding portion of the stationary valve seat and through the predetermined opening to be expelled from the apparatus.

7. The apparatus according to claim 1, wherein the stationary valve seat has a fluid outlet, and wherein in the closed position fluid flow through the fluid outlet is prevented.

8. The apparatus according to claim 7, wherein the fluid outlet is at least one opening in the stationary valve seat, and wherein the at least one protruding portion substantially surrounds the opening.

9. The apparatus according to claim 8, wherein the fluid outlet is at least one opening in the stationary valve seat, and wherein the stationary valve seat has a plurality of protruding portions that substantially surround the opening.

13. A method, comprising:
moving a moveable plunger assembly having a seal assembly, the seal assembly having at least a deformable end surface, between a closed position that prevents fluid flow and an open position that allows fluid flow; and
engaging, in the closed position, at least one protruding portion of a stationary valve seat with the deformable end surface of the seal assembly such that the at least one protruding portion is substantially embedded in the deformable end surface of the seal assembly;
wherein in the closed position the predefined surface of the stationary valve seat substantially contacts the deformable end surface of the seal assembly so as to provide a repeatable accurate closed position.

14. The method according to claim 13, wherein in the closed position the at least one protruding portion of the stationary valve seat indents the second predetermined area of the end surface of the moveable plunger assembly to create a substantially fluid tight seal.

15. The method according to claim 14, wherein the seal assembly is formed from one of a deformable elastimer material and a soft plastic material.

16. The method according to claim 13, wherein the end surface of the moveable plunger assembly has the second predetermined area end surface of the moveable plunger assembly recessed from the first predetermined area end surface of the moveable plunger assembly to create a predetermined opening, wherein the at least one protruding portion of the stationary valve seat extends through the predetermined opening end surface of the moveable plunger assembly to engage the second predetermined area of the end surface of the moveable plunger assembly.

17. The method according to claim 16, wherein the apparatus has an open position in which the at least one protruding portion of the stationary valve seat is disengaged from the end surface of the moveable plunger assembly to allow fluid to flow through the predetermined opening.

18. The method according to claim 17, wherein in the open position fluid flows into the apparatus between the predefined surface of the stationary valve seat and the end surface of the moveable plunger assembly, past the at least one protruding portion of the stationary valve seat and through the predetermined ;opening to be expelled from the apparatus.

19. The method according to claim 13, wherein the stationary valve seat has a fluid outlet, and wherein in the closed position fluid flow through the fluid outlet is prevented.

20. The method according to claim 19, wherein the fluid outlet is at least one opening in the stationary valve seat, and wherein the at least one protruding portion substantially surrounds the opening.

21. An apparatus, comprising:
a printing unit having a spraybar assembly;
the spraybar assembly having a plurality of spraybars;
a spraybar controller unit operatively coupled to the plurality of spraybars, the spraybar controller controlling operation of the plurality of spraybars;
a solution supply/processing equipment unit operatively coupled to the plurality of spraybars, the solution supply/processing equipment unit supplying dampening fluid to the plurality of spraybars;
each spraybar of the plurality of spraybars having at least one spray dampening valve, the spray dampening valve having a stationary valve seat having a predefined surface and having at least one protruding portion, and a moveable plunger assembly having a seal assembly, the seal assembly having at least a deformable end surface;
wherein in a closed position the predefined surface of the stationary valve seat substantially contacts a first predetermined area of the end surface of the moveable plunger assembly, and wherein in the closed position the at least one protruding portion of the stationary valve seat engages a second predetermined area of the end surface of the moveable plunger assembly,
wherein in a partially closed position of the spray dampening valve the predefined surface of the valve seat is spaced apart from the first predetermined area of the end surface of the moveable plunger assembly, and wherein the at least one protruding portion of the moveable plunger assembly contacts the second predetermined area of the end surface of the moveable plunger assembly, and
wherein in an open position of the spray dampening valve the predefined surface of the valve seat is spaced apart from the end surface of the moveable plunger assembly.

22. The apparatus according to claim 21, wherein in the closed position the at least one protruding portion of the stationary valve seat indents the second predetermined area of the end surface of the moveable plunger assembly to create a substantially fluid tight seal.

23. The apparatus according to claim 22, wherein the seal assembly is formed from one of a deformable elastimer material and a soft plastic material.

24. The apparatus according to claim 21, wherein the end surface of the moveable plunger assembly has the second predetermined area end surface of the moveable plunger assembly recessed from the first predetermined area end surface of the moveable plunger assembly to create a predetermined opening, wherein the at least one protruding portion of the stationary valve seat extends through the predetermined opening end surface of the moveable plunger assembly to engage the second predetermined area of the end surface of the moveable plunger assembly.

25. The apparatus according to claim 24, wherein the apparatus has an open position in which the at least one protruding portion of the stationary valve seat is disengaged from the end surface of the moveable plunger assembly to allow fluid to flow through the predetermined opening.

26. The apparatus according to claim 25, wherein in the open position fluid flows into the apparatus between the predefined surface of the stationary valve seat and the end surface of the moveable plunger assembly, past the at least one protruding portion of the stationary valve seat and through the predetermined opening to be expelled from the apparatus.

27. The apparatus according to claim 21, wherein the stationary valve seat has a fluid outlet, and wherein in the closed position fluid flow through the fluid outlet is prevented.

28. The apparatus according to claim 27, wherein the fluid outlet is at least one opening in the stationary valve seat, and wherein the at least one protruding portion substantially surrounds the opening.

29. The apparatus according to claim 28, wherein the fluid outlet is at least one opening in the stationary valve seat, and wherein the stationary valve seat has a plurality of protruding portions that substantially surround the opening.
